(19) United States
(12) Patent Application Publication
(10) Pub. No.: US 2008/0070159 A1
(43) Pub. Date: Mar. 20, 2008

(54) Stereolithography resins and methods

(75) Inventors: Manuel Jacinto Ramos, Santiago (CL); James P. Harrison, Pembroke Pines, FL (US); Alma L. Coats, Delray Beach, FL (US); James Scott Hay, Parkland, FL (US)

Correspondence Address: STEPTOE & JOHNSON LLP, 1330 CONNECTICUT AVENUE, N.W., WASHINGTON, DC, 20036, US

(73) Assignee: 3 Birds, Inc., Pompano Beach, FL (US)

(21) Appl. No.: 11/863,467

(22) Filed: Sep. 28, 2007

Related U.S. Application Data
(63) Continuation of application No. PCT/US2006/011977, filed on Apr. 3, 2006.
(60) Provisional application No. 60/667,079, filed on Apr. 1, 2005.

(30) Foreign Application Priority Data
Apr. 3, 2006 (US) PCT/US2006/011977

(51) Int. Cl. G03C 1/73; G03C 5/00

(52) U.S. Cl. 430/286.1; 430/270.1; 430/327

(57) ABSTRACT

Radiation curable resin compositions are provided that are most useful in stereolithography. A radiation curable resin includes a base oligomer, a cross linking agent, a reactive solvent, and an anti-nucleation agent. The resin after curing provides a solid product that has improved physical properties.

### CLAIM OF PRIORITY

This application is being filed under 35 U.S.C. §120 as a continuation of PCT/US2006/011977 designating the United States filed on Apr. 3, 2006, which claims priority from U.S. Patent Application Ser. No. 60/667,079 filed on Apr. 1, 2005, each of which is hereby incorporated by reference.

### TECHNICAL FIELD

This invention relates to resins and methods for stereolithography.

### BACKGROUND

Rapid prototyping includes a group of technologies that create three-dimensional objects by the successive formation of solid layers from a fluid-like material adjacent to previously formed solid layers of material according to cross-sectional data representing successive slices of the three-dimensional object.

In one type of rapid prototyping, called stereolithography, a liquid material is selectively solidified by exposing it to actinic radiation. The liquid material is typically a photopolymerizable material. The actinic radiation is typically visible or ultraviolet electromagnetic radiation. The radiation can be produced using a laser, though other sources of radiation are possible, such as arc lamps or resistive lamps. Selective exposure may occur by scanning a beam, or by controlling a flood exposure by use of a light valve that selectively transmits or reflects the radiation. After an object has been formed by stereolithography, it can be heat cured. Liquid-based stereolithography is discussed, for example, in U.S. Pat. No. 6,406,658, assigned to 3-D Systems, which is incorporated by reference in its entirety. Examples of stereolithography systems include the SLA 5000 and SLA 7000 models which are sold by 3D Systems, Inc (Valencia, Calif.).

A second type of rapid prototyping is known as selective laser sintering (SLS). SLS is based on the selective solidification of layers of a powdered material by exposing the layers to infrared electromagnetic radiation to sinter or fuse the powder particles. SLS is described, for example, in U.S. Pat. No. 4,863,538, which is incorporated by reference in its entirety.

A third type of rapid prototyping is known as three dimensional printing (3DP). 3DP is based on the selective solidification of layers of a powdered material by the selective deposition (e.g., from an ink-jet printer) of a binder thereon. 3DP is described in U.S. Pat. No. 5,204,055, which is incorporated by reference in its entirety.

### SUMMARY

In general, a stereolithography resin can include a base oligomer, a reactive solvent, a cross linking agent, and an anti-nucleation agent. The properties of products made by stereolithography using the resins can be controlled by choosing the identities and relative concentrations of the urethane acrylate oligomer, reactive solvent, and cross linking agent. In particular, products having shrink resistance, anti-nucleation properties, flame retardant properties, good dimensional stability, toughness, flexibility, heat resistance, or other desirable properties can be made using the resins.

In one aspect, a liquid stereolithography resin includes a base oligomer, a reactive solvent, a cross linking agent, and an anti-nucleation agent. In another aspect, a liquid stereolithography resin includes a base oligomer, a reactive solvent, a cross linking agent, and a halogenated organopnictide. In another aspect, a method of forming a three-dimensional object includes choosing a precursor based on a performance characteristic of a finished product, mixing the precursor with a stock solution including a urethane acrylate oligomer and an reactive solvent to form a stereolithography resin, and selectively exposing the resin to light to form a solidified layer. The performance characteristic can be hardness, flexibility, dimensional stability, clarity, toughness, elasticity, heat resistance, weather resistance, and combinations thereof. In another aspect, a method of forming a three-dimensional object includes selectively exposing to actinic radiation a first portion of a resin including a base oligomer, a reactive solvent, and a cross linking agent to form a first solidified layer, and selectively exposing to actinic radiation a second portion of the resin to form a second solidified layer adjacent to the first solidified layer.

The liquid stereolithography resin can include a photoinitiator. The photoinitiator can include a phosphine oxide, an alpha-hydroxyketone, benzophenone derivative, or mixtures thereof. The photoinitiator can include a component. The component can be a benzophenone, a benzil dimethyl ketal, a (1-hydroxycyclohexyl)phenylketone, an isopropyl thioxanthone, an ethyl 4-(dimethylamino)benzoate, a blend of 2,4,6-trimethylbenzoyldiphenyl phosphine oxide, 2,4,6-trimethylbenzophenone, 4-methylbenzophenone, and oligo(2-hydroxy-2-methyl-1-(4-(1-methylvinyl)phenyl)propanone, a benzoin normal butyl ether, a blend of oligo(2-hydroxy-2-methyl-1-4-(1-methylvinyl)phenyl propanone and poly(2-hydroxy-2-methyl-1-phenyl-1-propanone), tripropyleneglycol diacrylate, an oligo(2-hydroxy-2-methyl-1-(4-(1-methylvinyl)phenyl)propanone), a 2-hydroxy-2-methyl-1-phenyl-1-propanone, a poly(2-hydroxy-2-methyl-1-phenyl-1-propanone), a trimethylolpropane triacrylate, a SARCURE SR1137, a SARCURE SR1130, a phosphine oxide, a 4-methylbenzophenone, a trimethylbenzophenone, a methylbenzophenone, a Blend of 2,4,6-trimethylbenzoyl-diphenyl-phosphineoxide and hydroxy-2-methyl-1-phenyl-propan-1-one, or mixtures thereof. The photoinitiator can activate polymerization of an acrylate in a wavelength range of 240 nm to 250 nm, 360 nm to 380 nm, or 390 nm to 410 nm.

The base oligomer can include an aliphatic urethane diacrylate. The aliphatic urethane diacrylate can be an aliphatic polyester urethane diacrylate. The reactive solvent can include a monovalent acrylate or a polyvalent acrylate.

The base oligomer can have formula (I): 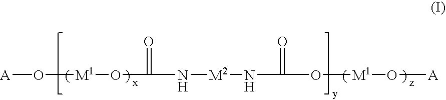
Each M¹ is, independently, an alkylene, an acylalkylene, an oxyalkylene, an arylene, an acylarylene, or an oxyarylene. Each M² is, independently, an alkylene or an arylene. Each M¹ and each M² can be optionally substituted with alkyl, cycloalkyl, alkenyl, cycloalkenyl, alkynyl, acyl, alkoxy, hydroxyl, hydroxylalkyl, halo, haloalkyl, amino, silicone, aryl, or aralkyl. In formula (I), x is a positive integer less than 40, y is a positive integer less than 100, and z is a positive integer less than 40. Each A, independently, has the formula: 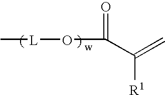
in which R¹ is hydrogen or lower alkyl, each L is, independently, C₁-C₄ alkyl, and w is an integer ranging from 0 to 20. R¹ is preferably hydrogen or methyl. In formula (I), w, x, y, and z together are selected such that the molecular weight of the base oligomer is less than 20,000.

In formula (I), M¹ can be a straight, branched, or cyclic alkylene. M¹ can be an acylalkylene or acylarylene. M² can be a straight, branched, or cyclic alkylene. L can be a branched or unbranched C₁-C₄ alkyl.

The reactive solvent can have formula (II):
A′-O—R²—(O-A′)ₙ (II)
R² is a monovalent or polyvalent moiety which can be a C₁-C₁₂ aliphatic group, an aromatic group, or a poly(C₁-C₄ branched or unbranched alkyl ether). R² can be optionally substituted with alkyl, cycloalkyl, alkenyl, cycloalkenyl, alkynyl, acyl, alkoxy, hydroxyl, hydroxylalkyl, halo, haloalkyl, amino, aryl, or aralkyl. In formula (II), n is an integer ranging from 0 to 5. Each A′ independently has the formula: 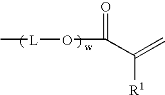
in which R¹ is hydrogen or lower alkyl, each L independently is C₁-C₄ alkyl, and w is an integer ranging from 0 to 20. R¹ is preferably hydrogen or methyl. In formula (II), L can be a branched or unbranched C₁-C₄ alkyl.

The cross linking agent can include an acrylate oligomer. The reactive solvent can have formula (III): 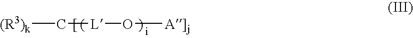
In formula (III), j is 1, 2, 3 or 4, k is equal to 4-j, R³ is hydrogen or C₁-C₄ branched or unbranched alkyl, each L′ independently is C₁-C₄ branched or unbranched alkyl, and each i independently is 0, 1, 2 or 3. Each A″ independently has the formula: 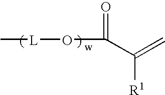
in which R¹ is hydrogen or lower alkyl, each L independently is C₁-C₄ branched or unbranched alkyl, and w is an integer ranging from 0 to 20.

The cross linking agent can include a second urethane acrylate oligomer. The cross linking agent can be a trimethylolpropane triacrylate, a bisphenol A dimethacrylate, a tripropyleneglycol diacrylate, a pentaerythritol tetraacrylate, a 2-(2-ethoxyethoxy)ethylacrylate, a tris(2-hydroxyethyl)isocyanurate triacrylate, an isobornyl acrylate, or mixtures thereof. In certain embodiments, the cross linking agent can include isobornyl acrylate.

The liquid stereolithography resin can include a stabilizer. The stabilizer can be Tinuvin 292 (bis(1,2,2,6,6-pentamethyl-4-piperidyl)sebacate and 1-methyl-10-(1,2,2,6,6-pentamethyl-4-piperidyl)sebacate), Tinuvin 765 (bis(1,2,2,6,6-pentamethyl-4-piperidyl)sebacate), MEQH (4-methoxyphenol), 2-(2′-hydroxy-5′-methylphenyl)benztriazole, 1,2,2,6,6-pentamethyl-4-piperidylmethacrylate or Chimassorb 81 (2-hydroxy-4-octyloxybenzophenone).

In one embodiment, the base oligomer is Sartomer CN964, the reactive solvent is Ethoxylated (3) trimethylolpropane acrylate, and the cross linking agent is Isobornyl acrylate, Ethoxylated (5) pentaerythritol tetraacrylate, Sartomer CN965, Tris-(2-hydroxyethyl)isocyanurate triacrylate, or mixtures thereof. The resin can include 5-35 weight % Sartomer CN964 and 0.5-25 weight % Ethoxylated (3) trimethylolpropane acrylate. The resin can include 0.5-20 weight % isobornyl acrylate. The resin can include 15-45 weight % Ethoxylated (5) pentaerythritol tetraacrylate. The resin can include 0.5-25 weight % Sartomer CN965. The resin can include 5-35 weight % Tris-(2-hydroxyethyl)isocyanurate triacrylate.

In another embodiment, the base oligomer is Sartomer CN963, the reactive solvent is Tripropyleneglycol diacrylate, and the cross linking agent is Sartomer CN970H75, Ethoxylated (4) bisphenol A dimethyacrylate, isobornyl acrylate, or mixtures thereof. The resin can include 40-70 weight % Sartomer CN963, and 5-35 weight % Tripropyleneglycol diacrylate. The resin can include 0.5-15 weight % Sartomer CN970H75. The resin can include 0.5-15 weight % Ethoxylated (4) bisphenol A dimethyacrylate. The resin can include 5-35 weight % Isobornyl acrylate.

In another embodiment, the base oligomer is Sartomer CN966, the reactive solvent is Isobornyl acrylate, and the cross linking agent is isobornyl acrylate, Ethoxylated (4) bisphenol A dimethyacrylate, or mixtures thereof. The resin can include 10-40 weight % Sartomer CN966 and 0.5-25 weight % isobornyl acrylate. The resin can include 6-35 weight % isobornyl acrylate. The resin can include 25-55 weight % Ethoxylated (4) bisphenol A dimethyacrylate.

In another embodiment, the base oligomer is Sartomer CN990, the reactive solvent is isobornyl acrylate, and the cross linking agent is Sartomer CN131, A polyether modified acryl functional polydimethylsiloxane, or mixtures thereof. The resin can include 50-80 weight % Sartomer CN990 and 0.5-20 weight % Isobornyl acrylate. The resin can include 5-35 weight % Sartomer CN131. The resin can include 0.5-15 weight % A polyether modified acryl functional polydimethylsiloxane.

In other embodiments, the base oligomer is Sartomer CN973, the reactive solvent is Isobornyl acrylate, and the cross linking agent is isobornyl acrylate. The resin can include 45-75 weight % Sartomer CN973 and 10-70 weight % isobornyl acrylate.

In other embodiments, the base oligomer is Sartomer CN963, the reactive solvent is Tripropyleneglycol diacrylate, and the cross linking agent is Sartomer CN2400, Isobornyl acrylate, or mixtures thereof. The resin can include 20-50 weight % Sartomer CN963 and 0.5-25 weight % Tripropyleneglycol diacrylate. The resin can include 10-40 weight % Sartomer CN2400. The resin can include 10-40 weight % Isobornyl acrylate.

In other embodiments, the base oligomer is Sartomer CN966, the reactive solvent is isobornyl acrylate, and the cross linking agent is Sartomer CN131, Isobornyl acrylate, or mixtures thereof. The resin can include 35-60 weight % Sartomer CN966 and 10-25 weight % Isobornyl acrylate. The resin can include 10-45 weight % Isobornyl acrylate. The resin can include 5-35 weight % Sartomer CN131.

The stock solution can include a photoinitiator and a stabilizer. The desired characteristic of the finished product can be dimensional stability and the precursor can be isobornyl acrylate.

In other embodiments, a radiation curable resin composition for preparing super flexible objects includes a urethane acrylate oligomer, an ethoxylated₃ trimethylolpropane triacrylate monomer, a polyethylene glycol diacrylate, and anti-nucleation agent, and one or more photoinitiators. In some embodiments a stabilizer is included in these compositions.

In another embodiment, a radiation curable resin composition for preparing a super high heat resistant object is provided includes a urethane acrylate oligomer, an ethoxylated₃ trimethylolpropane acrylate monomer a triacrylate monomer, an anti-nucleation agent, one or more photoinitiators and one of a tetra-acrylate monomer (such as an ethoxylated pentaerythritol tetraacrylate) and a monoacrylate monomer. In some embodiments, a stabilizer is included in these compositions.

In accordance with other embodiments, three dimensional objects are provided which are prepared using the radiation curable resins described above. Such three dimensional objects have desirable properties for many different commercial, industrial and consumer applications.

In accordance with other embodiments, methods for manufacturing objects by stereolithography using the radiation curable resins described above are provided.

A method for manufacturing a three-dimensional object by stereolithography is provided, including heating a base oligomer, applying heat to a cross-linker, mixing the base oligomer and cross linking agent under elevated temperature, adding a reactive solvent, slowly reducing the temperature. A second oligomer may be added to the mixture.

The various embodiments of the present invention provide a number of advantages, such as low viscosity, low volumetric shrinkage, anti-nucleation properties, decreased crystallization, and flame-retardation.

Radiation curable resins based on urethane-acrylate (UA) oligomers usually have high viscosity and lower physical properties in comparison with other systems (e.g. epoxies and epoxies-acrylate resins). These disadvantages in combination with a high amount of volumetric shrinkage have disqualified UA compositions from applications where high dimensional accuracy and low viscosity are required.

The high viscosity associated to UA compositions can be reduced with the increment of reactive solvents (usually monomers with low functionality and low molecular weight). Problems associated with this practice are that doing this, the physical properties of the cured resin are poor and the speed of curing of the resin is too low, requiring longer exposure to the actinic source. Another solution is the inclusion of non-reactive organic solvent, but these can leach out of the cured parts and become a health hazard. Sometimes, most of the non-reactive organic solvent remains in the vat of the SLA machine and with the continuous usage of the resin, the concentration of reactive material decrease in comparison with the amount of non-reactive solvent, which yields into different compositions with different physical properties once cured. This lack of uniformity in the properties that can be obtained from a resin is highly undesirable.

Several manufacturers have produced a generation of novel oligomers with low viscosity and enhanced physical properties. However, one of the limitations of these raw materials are it tendency to crystallize in the uncured form. The low molecular weight and the linear segments of urethane oligomer allows these materials to arrange the molecules and form crystals.

In order to include these new oligomers in radiation curable resins that should stay in liquid form at room temperature (approximately 25° C.) it is necessary to prevent the crystallization. Formulations including oligomers in combination with “anti-nucleation agents” that prevent the formation of crystalline structures of the uncured materials, the processes to make such materials, and their application in stereolithography.

In order to include these new UA oligomers in radiation curable resins that should stay in liquid form at room temperature (approximately 25° C.) it is advantageous to prevent the crystallization. Formulations containing crystalline oligomers in combination with “anti-nucleation agents” can prevent the formation of crystalline structures of the uncured materials.

A stereolithography resin can include an epoxy-acrylate resin. Epoxy-acrylate resins can suffer from excessive shrinkage upon curing, insufficient flexibility, insufficient toughness, or insufficient strength.

When formulating a resin for stereolithography, it can be important to control cure speed. Fast curing enables the stereolithographer to input conservative build parameters into stereolithography instrumentation to produce parts that are dimensionally accurate (within the limitations of the actual technology). Stereolithography resins having faster cure speeds can therefore be advantageous.

Stereolithography resins can preferably be formulated to enable the stereolithographer to finish parts without damage. Parts produced using stereolithographic instrumentation (e.g., those sold by 3D Systems) can be produced with support structures that encumber much of the part. Removal of these support structures prior to performing a finish cure and/or any finish application (i.e., in the green state) on the parts being processed can damage the product.

It can be preferable for radiation curable resins useful for stereolithography to have flame retardant qualities, dimensional stability and accuracy both during and after processing, to provide mechanical and physical stability in multiple environments exhibiting build chamber condition independence (i.e., the resin can be cured by anti-nucleation, laser light of various wavelengths), and to have high heat deflection temperatures and low shrinkage after curing. It can be preferable for resins to cure faster than currently available resins while maintaining performance characteristics that fit applicable materials design. There is a need for resins that are mechanically strong during the green state with easy-to-remove support structure. This can allow the operator to achieve and/or preserve fine smooth surfaces and thin walls (e.g. 0.045 inches thick). The properties of the green state are determined by the characteristics of the stereolithographic resin used.

Stereolithographic resins can exhibit a number of advantageous properties such as improved flexibility and high melting point, lower the freezing point, and lower volumetric shrinkage. Preferably, the resins have superior curing speeds as compared with commercially available stereolithography resins. Moreover, the resins can be cured over a wide range of light wavelengths, for example, the resins can be cured with light in the range of 240 nm to 250 nm, 360 nm to 380 nm, or 390 nm to 410 nm.

The details of one or more embodiments are set forth in the description below. Other features, objects, and advantages will be apparent from the description and from the claims.

### DETAILED DESCRIPTION

The properties of a product made by stereolithography can be controlled by the stereolithography resin from which it is made. The resin can be formulated such that products made from it have low viscosity, low volumetric shrinkage, and improved physical properties. The resin can be have a higher melting point and lower freezing point, be flexible, or tough.

The degree to which a product has one or more of these properties can be controlled by the choice of components in a resin, and the relative amounts of the components in the resin. Examples of resins are described, for example, in U.S. Pub. No. 20040135292, which is hereby incorporated by reference in its entirety.

Several manufacturers have produced a generation of novel oligomers with low viscosity and enhanced physical properties, offering a solution to overcome the common problems associated with compositions based in this kind of chemistry. One of the limitations of these raw materials are it tendency to crystallize in the uncured form; the low molecular weight and the linear segments of urethane oligomer allows these materials to arrange the molecules and form crystals.

In order to include these new oligomers in radiation curable resins that should stay in liquid form at room temperature (approximately 25° C.) it is advantageous to prevent the crystallization.

Formulations containing oligomers in combination with anti-nucleation agents can prevent the formation of crystalline structures of the uncured materials. A resin can include a base oligomer, a cross linking agent or cross linker, a reactive solvent, and an anti-nucleation agent, or a combination thereof. A photoinitiator can also be included to any of the aforementioned components.

A base oligomer can include a urethane acrylate oligomer with a functionality equal to (2) and molecular weight between 600 and 5000 g/mol. A urethane acrylate oligomer can have a linear or unbranched structure, with some crystalline degree in the uncured form. One example of a base oligomer suitable for this application is a aliphatic urethane di-acrylate oligomer (CN985 from Sartomer). Another example is an 88:12 mixture of CN985 with 1,6-hexanediol diacrylate monomer (CN985B88 from Sartomer). Another example is an aliphatic urethane di-acrylate oligomer (Actilane 170 from Akzo Nobel).

A cross linking agent can be selected from the group of (meth)acrylate monomers or polyester oligomers, with functionality equal to or higher than two (2) and some crystalline degree in uncured form. One example of a cross linking agent suitable for this application is tris (2-hydroxy ethyl) isocyanurate triacrylate (SR363 from Sartomer or THEIC Triacrylate from Hampford Research). Another example of a cross linking agent is ethoxylated (4) bisphenol dimethacrylate (CD540 from Sartomer, BX-BPA(2EO)DMA from Bimax Chemicals, and AGEFLEX EO4BDMA from Ciba SC).

A reactive solvent can include a (metha)acrylate monomer with functionality equal to one (1). The selected monomer must have a Hildebrand Solubility Parameter delta δ that matches the Hildebrand Solubility Parameter delta δ of the base oligomer. The selection of the reactive solvent and amount to be added can be based on the amount required to achieve a low viscosity mixture and the desired physical properties of the cured resin. Examples of a reactive solvent include isobornyl acrylate (SR506 from Sartomer), isobornyl methacrylate (SR423 from Sartomer) and mixtures of these two.

An anti-nucleation agent can include a substance with low molecular weight, incapable to polymerize, with functional groups that can form meta-stable links with the cross-linker and the base oligomer, and prevent crystallization of these two in the uncured resin. One example of an anti-nucleation agent is chlorinated phosphate ester as 1,3-dichloro-2-propanol phosphate (Antiblaze TMCP from Albemarle, Fyrol FR2 from Akzo Nobel). Each of these components can be selected individually, or a blend of urethane acrylate oligomer and an reactive solvent can be precombined as a stock solution, for the production of radiation curable resins having different performance characteristics.

The anti-nucleation agent can be a pnictide-containing compound, for example. Pnictide-containing compounds can include an organopnictide and a halogenated organopnictide, such as a chlorinated phosphate ester.

A pnictide-containing compound is a compound of phosphorus, arsenic, antimony or bismuth. The phosphorus, arsenic, antimony or bismuth can be phosphorus oxide, arsenic oxide, antimony oxide or bismuth oxide. An organopnictide is a pnictide-containing compound including at least one organic moiety, for example, an alkyl, an alkenyl, an alkynyl, a cycloalkeyl or an aryl group. The organic moiety can have between 2 and 50 carbon atoms. The organic moiety can be substituted or unsubstituted with C₁₋₄ alkyl, C₂₋₄ alkenyl, C₂₋₄ alkynyl, C₁₋₄ alkoxy, hydroxyl, halo, amino, nitro, cyano, C₃₋₅ cycloalkyl, 3-5 membered heterocycloalkyl, monocyclic aryl, 5-6 membered heteroaryl, C₁₋₄ alkylcarbonyloxy, C₁₋₄ alkyloxycarbonyl, C₁₋₄ alkylcarbonyl, or formyl. When the organic moiety is substituted by halo, for example, fluorine, chlorine, bromine, or iodine, compound is a halogenated organopnictide.

Alkyl is a straight or branched hydrocarbon chain containing 1 to 10 (preferably, 1 to 6; more preferably 1 to 4) carbon atoms. Examples of alkyl include, but are not limited to, methyl, ethyl, propyl, isopropyl, butyl, isobutyl, sec-butyl, tert-butyl, n-pentyl, 2-methylhexyl, and 3-ethyloctyl.

Alkenyl and alkynyl refer to a straight or branched hydrocarbon chain containing 2 to 10 carbon atoms and one or more (preferably, 1-4 or more preferably 1-2) double or triple bonds, respectively. Some examples of alkenyl and alkynyl include allyl, 2-butenyl, 2-pentenyl, 2-hexenyl, 2-butynyl, 2-pentynyl, and 2-hexynyl.

Cycloalkyl is a monocyclic, bicyclic or tricyclic alkyl group containing 3 to 14 carbon atoms. Some examples of cycloalkyl include cyclopropyl, cyclopentyl, cyclohexyl, cycloheptyl, adamantyl, and norbornyl. Heterocycloalkyl is a cycloalkyl group containing at least one heteroatom (e.g., 1-3) such as nitrogen, oxygen, or sulfur. The nitrogen or sulfur may optionally be oxidized and the nitrogen may optionally be quaternized. Examples of heterocycloalkyl include piperidinyl, piperazinyl, tetrahydropyranyl, tetrahydrofuryl, and morpholinyl. Cycloalkenyl is a cycloalkyl group containing at least one (e.g., 1-3) double bond. Examples of such a group include cyclopentenyl, 1,4-cyclohexa-di-enyl, cycloheptenyl, and cyclooctenyl groups. By the same token, heterocycloalkenyl is a cycloalkenyl group containing at least one heteroatom selected from the group of oxygen, nitrogen or sulfur.

Aryl is an aromatic group containing a 5-14 ring and can contain fused rings, which may be saturated, unsaturated, or aromatic. Examples of an aryl group include phenyl, naphthyl, biphenyl, phenanthryl, and anthracyl. If the aryl is specified as “monocyclic aryl,” if refers to an aromatic group containing only a single ring, i.e., not a fused ring.

Heteroaryl is aryl containing at least one (e.g., 1-3) heteroatom such as nitrogen, oxygen, or sulfur and can contain fused rings. Some examples of heteroaryl include pyridyl, furanyl, pyrrolyl, thienyl, thiazolyl, oxazolyl, imidazolyl, indolyl, benzofuranyl, and benzthiazolyl.

The cyclic moiety can be a fused ring formed from two or more of the just-mentioned groups. Examples of a cyclic moiety having fused rings include fluorenyl, dihydro-dibenzoazepine, dibenzocycloheptenyl, 7H-pyrazino[2,3-c]carbazole, or 9,10-dihydro-9,10-[2]buteno-anthracene.

Flame retardants are agents or additives that help to prevent ignition or spread of flame in plastic material. A flame retardant additive prevents combustion, the process by which a mixture of volatile substances, air within flammability limits, and temperature reach a level beyond the ignition point. Flame retardant additives can reduce the heat supplied to the polymer by modifying the rate of chemical and physical processes. Flame retardant additives can include compounds, such as halogenated compounds, phosphorous compounds, halogenated organic pnictides, inorganic materials, radical initiators, aliphatic halides, and nitrogen and boron based additives.

Flame retardant additives can interrupt the physical and chemical processes of the combustion by reducing the exothermic processes, cooling down the system, reducing the supply of the flammable gases and eventually suppress the fire. Flame retardant materials can also shield a combustible condensed phase with a solid or liquid protective layer. As the condensed phase cools, oxygen is excluded and heat transfer is impeded. Flame retardant materials can incorporate inert substances that can dilute fuel in both gas and solid phases and lowers the ignition point of the mixture.

Flame retardant additives can also work by increasing polymer breakdown, thereby increasing the flow of the polymer and withdrawing the flame away from its sphere or influence.

Flame retardant additives can be selected for various properties, such as a matchup decomposition temperature or a flame retardant with the self-ignition temperature of a polymer, thermal stability, efficiency, ability to meet specific fire safety standards, the effect on physical properties, melt flow, UV stability, cost, electrical properties, thermal aging, and recyclability.

A resin can be formed by heating a main oligomer to reach a temperature between 50° C. and 60° C. in order to melt a crystal or simply reduce its viscosity. The range of temperature can be controlled so as to avoid degradation of the raw material. If the cross-linker is also crystalline at room temperature, heating may be applied to melt its crystals. At 50° C., the tris(2-hydroxy ethyl)isocyanurate triacrylate is a low viscosity monomer and can be a good solvent for urethane acrylate oligomers. The main oligomer and the cross-linker can be mixed under elevated temperature (40° C.). A second oligomer can be optionally added to this mixture. A reactive solvent, which can be selected from a group of acrylate monomers, can be added to slowly reduce the temperature to 30° C. An anti-nucleation agent can be added to the mixture. A photoinitiator can be added to the mixture. Additional stirring at low shear is recommended to ensure full mixture of the resin.

A base oligomer can have formula (I): 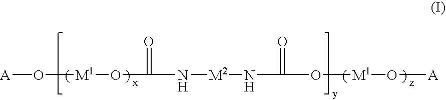
Each M¹ is, independently, an alkylene, an acylalkylene, an oxyalkylene, an arylene, an acylarylene, or an oxyarylene. Each M² is, independently, an alkylene or an arylene. Each M¹ and each M² are optionally substituted with alkyl, cycloalkyl, alkenyl, cycloalkenyl, alkynyl, acyl, alkoxy, hydroxyl, hydroxylalkyl, halo, haloalkyl, amino, silicone, aryl, or aralkyl. In formula (I), x is a positive integer less than 40, y is a positive integer less than 100, and z is a positive integer less than 40. Each A, independently, has the formula: 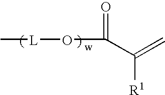
R¹ is hydrogen or lower alkyl, each L is, independently, C₁-C₄ alkyl, and w is an integer ranging from 0 to 20. In formula (I), w, x, y, and z together are selected such that the molecular weight of the base oligomer is less than 20,000. More particularly, M¹ can be acylalkylene and M² can be alkylene or arylene. Examples of urethane acrylate oligomers include CN963, CN964, CN965, CN966, CN970, CN973, and CN990, all of which are available from Sartomer (Exton, Pa.).

A reactive solvent or cross linking agent can have formula (II):
A′-O—R²—(O-A′)ₙ (II)
R² is a monovalent or polyvalent moiety which can be a C₁-C₁₂ aliphatic group, an aromatic group, or a poly(C₁-C₄ branched or unbranched alkyl ether). R² is optionally substituted with alkyl, cycloalkyl, alkenyl, cycloalkenyl, alkynyl, acyl, alkoxy, hydroxyl, hydroxylalkyl, halo, haloalkyl, amino, aryl, or aralkyl. In formula (II), n is an integer ranging from 0 to 5. Each A′ has the formula: 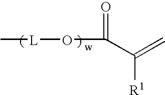
R¹ is hydrogen or lower alkyl, each L independently is C₁-C₄ alkyl, and w is an integer ranging from 0 to 20. More particularly, a reactive solvent or cross linking agent can have formula (III): 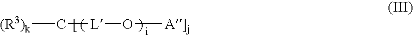
In formula (III), j is 1, 2, 3 or 4, k is equal to 4-j, R³ is hydrogen or C₁-C₄ branched or unbranched alkyl, each L′ independently is C₁-C₄ branched or unbranched alkyl, and each i independently is 0, 1, 2 or 3. Each A″ independently has the formula: 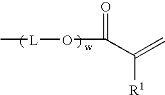
R¹ is hydrogen or lower alkyl, each L independently is C₁-C₄ branched or unbranched alkyl, and w is an integer ranging from 0 to 20. Examples of acrylate monomers include ethoxylated trimethylolpropane triacrylate, ethoxylated bisphenol A dimethacrylate, tripropyleneglycol diacrylate, pentaerythritol tetraacrylate, 2-(2-ethoxyethoxy)ethylacrylate, tris(2-hydroxyethyl)isocyanurate triacrylate, and isobornyl acrylate, all of which are available from Sartomer (Exton, Pa.).

A stereolithography resin can be formulated for general purpose products (a general purpose resin). A product prepared from a general purpose resin can be useful in products such as parts that snap-fit together or that have clips that need some flexibility. A general purpose resin can be useful, among other applications, for PDA (personal data assistant) housings, blender housings and cell phone housings.

A stereolithography resin can be formulated for flexible products (a flexible resin). A product prepared from a flexible resin can be flexible and can be especially useful for simulating rubber and silicone type materials. A flexible resin can be useful in, for example, gaskets, dive masks, switch knobs, face masks for respirators and cell phone keypads. More particularly, a stereolithography resin can be formulated for preparing products with a moderate flexibility (a mid flex resin). A product prepared from a mid flex resin can be suitable for the construction of pieces such as hinges, caps, rigid packaging (bottles, cases, etc.) and others. A product prepared from a mid flex resin can show moderate flexibility and low resistance to plastic deformation, and can emulate the mechanical properties of high-density polyethylene (HDPE). A product prepared from a super flex resin can be more flexible than a mid flex resin.

A stereolithography resin can be formulated for a product that is resistant to high heat (a high heat resin). A product resistant to high heat can have a flexibility of about 10 degrees before breaking and a T_{g} of about 460° F. In contrast, typical commercially available resins yield products that are extremely brittle and have T_{g} values of between 350 and 400° F. A high heat resin can be used effectively, for example, in test components for automotive engines, aerospace applications, engine blocks or manifold, jet engine components and heat sinks. A high heat resin can emulate the thermal properties of polyamides.

A stereolithography resin can be formulated for preparing a tough and hard product (a tough and hard resin). A product made from a tough and hard resin can be difficult to break and relatively inflexible. A tough and hard resin can be useful for simulating production materials such as ABS plastic, for instance in automotive parts, power tool components and cell phone housings.

A stereolithography resin can be formulated for preparing products with high toughness (a tough resin). A product prepared from a tough resin can require moderate to high stresses to produce deformation, can be resistant to fatigue and can deform in large extensions without breaking (plastic deformation), for example, elongation of 85-180% without breaking. A tough resin can emulate the properties of polycarbonate and polypropylene, and can be suitable for the construction of products that require high mechanical resistance, such as gear wheels, engine parts, and PDA and cellular phones cases.

A stereolithography resin can be formulated for preparing products with characteristics of a soft rubber (a soft rubber resin). A product prepared from a soft rubber resin can be flexible, elastic and offer low resistance to elastic deformation. A product prepared from a soft rubber resin can have a Shore D hardness in the range of 10-20. Such resins can emulate the properties of elastomers such as polybutadiene and polyisoprene, and can be suitable for the construction of products such as gaskets, engine belts, cell phone keypads, tubing, or medical devices. Also, the soft rubber resin can be used to emulate human tissues.

A stereolithography resin can be formulated for preparing products with the characteristics of a rubber with medium stiffness (a mid-rubber resin). An object prepared from the mid rubber resin can be flexible, with good hardness and superficial properties (i.e. resistance to abrasion) and resistant to elastic deformation. A product prepared from a mid-rubber resin can have a Shore D hardness in the range of 30-45. Such resins can simulate the physical properties of silicone rubbers, making it suitable for the construction of products such as respirator masks, catheters, cell phone keypads, o-rings, or cushion pads.

A stereolithography resin can be formulated for preparing products with the characteristics of a hard rubber (a hard rubber resin). A product prepared from a hard rubber resin can be flexible and elastic, with high hardness and can require high stress to produce an elastic deformation. A product prepared from a hard rubber resin can have a Shore D hardness in the range of 60-80. A product prepared form a hard rubber resin can emulate highly cross-linked elastomers, rubbers with inorganic fillers, polyurethane elastomers, nitrile-butadiene rubber (NBR) and styrene-butadiene rubber (SBR), and can be suitable for the construction of products such as shoe soles, engine belts, or tires.

A stereolithography resin can be formulated for preparing products with metallic properties (a metallic resin). An object prepared from a metallic resin can be strong and virtually not deformable, can emulate the properties of a polyacetal, and can be suitable for the construction of products that require extreme mechanical resistance without any kind of deformation and high resistance over time.

A general purpose resin can include a base oligomer, a reactive solvent, a cross linking agent, and an anti-nucleation agent. The base oligomer can include an aliphatic polyester urethane diacrylate. The reactive solvent can include a polyvalent acrylate, for example an ethoxylated trimethylolpropane acrylate. The cross linking agent can include a polyvalent acrylate, such as a di, tri, tetra, penta or higher acrylate, for example, an ethoxylated pentaerythritol tetraacrylate, or an isocyanurate triacrylate. The cross linking agent can include a second urethane acrylate oligomer. The resin can also include a photoinitiator and a stabilizer.

A flexible resin can include a base oligomer such as a urethane acrylate oligomer, an acrylate monomer, a cross linking agent, and an anti-nucleation agent. The urethane acrylate oligomer can include an aliphatic polyester urethane diacrylate. The acrylate monomer can include a polyvalent acrylate, such as an ethoxylated trimethylolpropane triacrylate, or a monovalent acrylate, such as isobornyl acrylate. The cross linking agent can include an alkoxylated cyclohexane diacrylate, isobornyl acrylate, an ethoxylated bisphenol A diacrylate, or mixtures thereof. The resin can also include a photoinitiator and a stabilizer.

A mid flex resin can include a urethane acrylate oligomer, an acrylate monomer, a cross linking agent, and an anti-nucleation agent. The urethane acrylate oligomer can include an elastic urethane acrylate oligomer. The acrylate monomer can include a monovalent acrylate such as isobornyl acrylate. The cross linking agent can include a polyvalent acrylate such as an ethoxylated bisphenol A dimethacrylate. The resin can include a photo-initiator and a stabilizer.

A super flex resin can include a urethane acrylate oligomer, an acrylate monomer, a cross linking agent, and an anti-nucleation agent. The urethane acrylate oligomer can include an aliphatic polyester urethane diacrylate, or a siliconized urethane acrylate oligomer. The acrylate monomer can include a diacrylate such as a polyethylene glycol diacrylate, or a monoacrylate such as isobornyl acrylate. The cross linking agent can include a second urethane acrylate oligomer, a low viscosity aromatic monoacrylate oligomer, or a polyether modified acrylic functional polydimethylsiloxane.

A high heat resin can include a urethane acrylate oligomer, an reactive solvent, cross linking agent, and an anti-nucleation agent. The urethane acrylate oligomer can include an aliphatic polyester urethane diacrylate, an aromatic polyester urethane diacrylate, or a combination. The reactive solvent can include a monovalent acrylate, such as isobornyl acrylate or a polyvalent acrylate, such as an ethoxylated bisphenol A diacrylate. The cross linking agent can include a polyvalent acrylate, such as an isocyanurate triacrylate. The resin can also include a photoinitiator and a stabilizer.

A tough and hard resin can include a urethane acrylate oligomer, an reactive solvent, a cross linking agent, and anti-nucleation agen. The urethane acrylate oligomer can include an aliphatic polyester urethane diacrylate, an aromatic polyester urethane diacrylate, or a combination. The reactive solvent can include a polyvalent acrylate, such as an ethoxylated trimethylolpropane triacrylate, or a 2-(2-ethoxyethoxy)ethylacrylate. The cross linking agent can include a second urethane acrylate oligomer which can be an aliphatic polyester urethane diacrylate, a monovalent acrylate, such as isobornyl acrylate, a polyvalent acrylate, such as an ethoxylated bisphenol A diacrylate, or a combination. The resin can also include a photoinitiator and a stabilizer.

A tough resin can include a urethane acrylate oligomer, an reactive solvent, a cross linking agent, and an anti-nucleation agent. The urethane acrylate oligomer can include an aromatic urethane acrylate oligomer. The reactive solvent can include a polyvalent acrylate such as an ethoxylated bisphenol A dimethacrylate. The cross linking agent can include an aliphatic urethane acrylate oligomer, a tripropyleneglycol diacrylate, an isocyanurate triacrylate, isobornyl acrylate, or a combination. The polymerization modifier can include tris(2-hydroxyethyl)isocyanurate triacrylate, which can allow control of the ultimate resistance to mechanical stress. The resin can include a photo-initiator and a stabilizer.

A soft rubber resin can include a urethane acrylate oligomer, an reactive solvent, a cross linking agent, and an anti-nucleation agent. The urethane acrylate oligomer can include a siliconized urethane acrylate oligomer. The reactive solvent can include a monovalent acrylate such as isobornyl acrylate. The cross linking agent can include a low viscosity aromatic monoacrylate oligomer. The resin can include a photo-initiator and a stabilizer.

A mid-rubber resin can include a urethane acrylate oligomer, an reactive solvent, a cross linking agent, and an anti-nucleation agent. The urethane acrylate oligomer can include a siliconized urethane acrylate oligomer. The reactive solvent can include a monovalent acrylate such as isobornyl acrylate. The cross linking agent can include a low viscosity aromatic monoacrylate oligomer, a polyether modified acrylic functional polydimethylsiloxane, or a combination. The resin can include a photo-initiator and a stabilizer.

A hard rubber resin can include a urethane acrylate oligomer, an reactive solvent, a cross linking agent, and an anti-nucleation agent. The urethane acrylate oligomer can include an aromatic urethane acrylate oligomer. The reactive solvent can include a monovalent acrylate such as isobornyl acrylate. The cross linking agent can include a monovalent acrylate such as isobornyl acrylate. The resin can include a photo-initiator and a stabilizer.

A metallic resin can include a urethane acrylate oligomer, an reactive solvent, a cross linking agent, and an anti-nucleation agent. The urethane acrylate oligomer can include an aliphatic urethane acrylate. The reactive solvent can include a polyvalent acrylate such as a tripropyleneglycol diacrylate. The cross linking agent can include a monovalent acrylate such as isobornyl acrylate. The cross linking agent can include a metallic acrylic oligomer.

Tables 1-9, below, illustrate various embodiments. Tables 1A and 1B describe general purpose resins. Tables 2A and 2B describe mid-flex resins. Tables 3A and 3B describe super flex resins. Table 4 describes a high-heat resin. Tables 5A and 5B describe tough resins. Table 6 describes a soft rubber resin. Table 7 describes a mid rubber resin. Table 8 describes a hard rubber resin. Table 9 describes a metallic resin. In the tables, the first column identifies the commercially available product used for each component, the second column describes the various components (e.g. urethane acrylate oligomer, photoinitiator, or stabilizer).

Example 1 provides a sample protocol for a method of preparing a stereolithographic resin. Examples 2-4 show examples of commercially available products for use. Examples 5-6 show the sample formulations, and Example 7 shows samples of viscosity and of uncured resin and physical properties of cured resin.

TABLE 1A

| | | Broad | Preferred | |
|---|---|---|---|---|
| | | range | range | Actual |
| | | (Volume | (Volume | composition |
| Components | Type | %) | %) | (Volume %) |
| CN964E75 | urethane acrylate | 18-42 | 25-35 | 30 |
| | oligomer | | | |
| SR494 | tetrareactive | 20-44 | 27-37 | 32 |
| | solvent | | | |
| CN965 | urethane acrylate | 1-24 | 7-17 | 12 |
| | oligomer | | | |
| SR368 | triacrylate | 4-28 | 11-21 | 16 |
| | monomer | | | |
| Darocur 4265 | photoinitiator | 1-14 | 1-7 | 2 |
| TIN292 | stabilizer | 1-20 | 3-13 | 8 |

TABLE 1B

| | | Broad range | Preferred range |
|---|---|---|---|
| Components | Type | (% w/w) | (% w/w) |
| CN964E75 | urethane acrylate | 14.8-38.8 | 21.8-31.8 |
| | oligomer | | |
| | aliphatic urethane | 8.1-32.1 | 15.1-25.1 |
| | acrylate (CN964) | | |
| | ethoxylated₃ | 1-18.7 | 1.7-11.7 |
| | trimethylolpropane | | |
| | triacrylate ester | | |
| SR506 | isobornyl acrylate | 1-14 | 1-7 |
| SR494 | ethoxylated₄ | 19.5-43.5 | 26.5-36.5 |
| | pentaerythritol | | |
| | tetraacrylate | | |
| CN965 | urethane acrylate | 1-23.4 | 6.4-16.4 |
| | oligomer | | |
| SR368 | tris(2-hydroxyethyl) | 6.2-30.2 | 13.2-23.2 |
| | isocyanurate triacrylate | | |
| Darocur 4265 | photoinitiator | 1-14.4 | 1-7.4 |
| TIN292 | stabilizer | 1-19.7 | 2.7-12.7 |

TABLE 2A

| | | Broad | | |
|---|---|---|---|---|
| | | range | Preferred | Actual |
| | | (Volume | range | composition |
| Components | Type | %) | (Volume %) | (Volume %) |
| CN964E75 | urethane acrylate | 22-46 | 29-39 | 34 |
| | oligomer | | | |
| SR494 | tetraacrylate | 15-39 | 22-32 | 27 |
| | monomer | | | |
| CN965 | urethane acrylate | 7-31 | 14-24 | 19 |
| | oligomer | | | |
| CN738 | polyester acrylic | 1-23 | 6-16 | 11 |
| | ester | | | |
| Darocur | photoinitiator | 1-14 | 1-7 | 2 |
| 4265 | | | | |
| TIN292 | stabilizer | 1-19 | 2-12 | 7 |

TABLE 2B

| | | Broad range | Preferred range |
|---|---|---|---|
| Components | Type | (% w/w) | (% w/w) |
| CN966J75 | urethane acrylate | 21.5-45.5 | 28.5-38.5 |
| | oligomer | | |
| | aliphatic urethane | 13.1-37.1 | 20.1-30.1 |
| | acrylate (CN966) | | |
| | isobornyl acrylate | 1-20.4 | 3.4-13.4 |
| SR506 | isobornyl acrylate | 6.5-30.5 | 13.5-23.5 |
| CD540 | ethoxylated₄ bisphenol | 29.8-53.8 | 36.8-46.8 |
| | A dimethacrylate | | |
| TIN292 | stabilizer | 1-16.1 | 1-9.1 |
| DAROCUR 4265 | photoinitiator | 1-14.1 | 1-7.1 |

TABLE 3A

| | | Broad | | |
|---|---|---|---|---|
| | | range | Preferred | Actual |
| | | (Volume | range | composition |
| Components | Type | %) | (Volume %) | (Volume %) |
| CN964E75 | urethane acrylate | 26-50 | 33-43 | 38 |
| | oligomer | | | |
| CN965 | urethane acrylate | 3-27 | 10-20 | 15 |
| | oligomer | | | |
| CN966J75 | urethane acrylate | 3-27 | 10-20 | 15 |
| | oligomer | | | |
| SR344 | diacrylate | 11-35 | 18-28 | 23 |
| | monomer | | | |
| Darocur | photoinitiator | 1-14 | 1-7 | 2 |
| 4265 | | | | |
| TIN292 | stabilizer | 1-19 | 2-12 | 7 |

TABLE 3B

| | | Broad range | Preferred range |
|---|---|---|---|
| Components | Type | (% w/w) | (% w/w) |
| CN990 | siliconized urethane | 52.4-76.4 | 59.4-69.4 |
| | acrylate oligomer | | |
| CN131 | low viscosity aromatic | 9.1-33.1 | 16.1-26.1 |
| | monoacrylate oligomer | | |
| SR506 | isobornyl acrylate | 1-18.7 | 1.7-11.7 |
| BYK3500 | polyether modified | 1-13 | 1-6 |
| | acrylic functional | | |
| | polydimethylsiloxane | | |
| TIN292 | stabilizer | 1-16.3 | 1-9.3 |
| DAROCUR 4265 | photoinitiator | 1-14.5 | 1-7.5 |

TABLE 4

| | | Broad | | |
|---|---|---|---|---|
| | | range | Preferred | Actual |
| | | (Volume | range | composition |
| Components | Type | %) | (Volume %) | (Volume %) |
| CN964E75 | urethane acrylate | 15-39 | 22-32 | 27 |
| | oligomer | | | |
| SR506 | monoacrylate | 2-26 | 9-19 | 14 |
| | monomer | | | |
| CN965 | urethane acrylate | 1-22 | 5-15 | 10 |
| | oligomer | | | |
| SR368 | triacrylate | 28-52 | 35-45 | 40 |
| | monomer | | | |
| Darocur | photoinitiator | 1-15 | 1-8 | 3 |
| 4265 | | | | |
| TIN292 | stabilizer | 1-18 | 1-11 | 6 |

TABLE 5A

| | | Broad | | |
|---|---|---|---|---|
| | | range | Preferred | Actual |
| | | (Volume | range | composition |
| Components | Type | %) | (Volume %) | (Volume %) |
| CN964E75 | urethane acrylate | 4-28 | 11-21 | 16 |
| | oligomer | | | |
| CN963A80 | urethane acrylate | 25-49 | 32-42 | 37 |
| | oligomer | | | |
| SR506 | monoacrylate | 25-49 | 32-42 | 37 |
| | monomer | | | |
| Darocur | photoinitiator | 1-15 | 1-8 | 3 |
| 4265 | | | | |
| TIN292 | stabilizer | 1-19 | 2-12 | 7 |

TABLE 5B

| | | Broad range | Preferred range |
|---|---|---|---|
| Components | Type | (% w/w) | (% w/w) |
| CN970H75 | urethane acrylate | 1-13.1 | 1-6.1 |
| | oligomer | | |
| | aromatic urethane | 1-12.8 | 1-5.8 |
| | acrylate (CN970) | | |
| | 2-(2-ethoxyethoxy) | 1-12.3 | 1-5.3 |
| | ethylacrylate | | |
| CD540 | ethoxylated₄ bisphenol | 1-13 | 1-6 |
| | A dimethacrylate | | |
| CN963A80 | urethane acrylate | 60-84 | 67-77 |
| | oligomer | | |
| | aliphatic urethane | 42-66 | 49-59 |
| | acrylate (CN963) | | |
| | tripropyleneglycol | 6-30 | 13-23 |
| | diacrylate | | |
| SR506 | isobornyl acrylate | 7.3-31.3 | 14.3-24.3 |
| Darocur 4265 | photoinitiator | 1-14.5 | 1-7.5 |
| TIN292 | stabilizer | 1-16.1 | 1-9.1 |

TABLE 6

| | | Broad range | Preferred range |
|---|---|---|---|
| Components | Type | (% w/w) | (% w/w) |
| CN966J75 | siliconized urethane | 54.1-78.1 | 61.1-71.1 |
| | acrylate oligomer | | |
| CN131 | low viscosity aromatic | 8.9-32.9 | 15.9-25.9 |
| | monoacrylate oligomer | | |
| SR506 | isobornyl acrylate | 1-18.7 | 1.7-11.7 |
| Darocur 4265 | photoinitiator | 1-14.1 | 1-7.1 |
| TIN292 | stabilizer | 1-16.2 | 1-9.2 |

TABLE 7

| | | Broad range | Preferred range |
|---|---|---|---|
| Components | Type | (% w/w) | (% w/w) |
| CN990 | siliconized urethane | 52.4-76.4 | 59.4-69.4 |
| | acrylate oligomer | | |
| CN131 | low viscosity aromatic | 9.1-33.1 | 16.1-26.1 |
| | monoacrylate oligomer | | |
| SR506 | isobornyl acrylate | 1-18.7 | 1.7-11.7 |
| BYK3500 | polyether modified | 1-13 | 1-6 |
| | acrylic functional | | |
| | polydimethylsiloxane | | |
| TIN292 | stabilizer | 1-16.3 | 1-9.3 |
| DAROCUR 4265 | photoinitiator | 1-14.5 | 1-7.5 |

TABLE 8

| | | Broad range | Preferred range |
|---|---|---|---|
| Components | Type | (% w/w) | (% w/w) |
| CN973J75 | urethane acrylate | 66-90 | 73-83 |
| | oligomer | | |
| | aromatic urethane | 46.5-70.5 | 53.5-63.5 |
| | acrylate (CN973) | | |
| | isobornyl acrylate | 7.5-31.5 | 14.5-24.5 |
| SR506 | isobornyl acrylate | 3.6-27.6 | 10.6-20.6 |
| TIN292 | stabilizer | 1-16.3 | 1-9.3 |
| DAROCUR 4265 | photoinitiator | 1-14.1 | 1-7.1 |

TABLE 9

| | | Broad range | Preferred range |
|---|---|---|---|
| Components | Type | (% w/w) | (% w/w) |
| CN2400 | metallic acrylic | 12.3-36.3 | 19.3-29.3 |
| | oligomer | | |
| CN963A80 | urethane acrylate | 33-57 | 40-50 |
| | oligomer | | |
| | aliphatic urethane | 21.8-45.8 | 28.8-38.8 |
| | acrylate (CN963) | | |
| | tripropyleneglycol | 1-23.3 | 6.3-16.3 |
| | diacrylate | | |
| SR506 | isobornyl acrylate | 12.3-36.3 | 19.3-29.3 |
| DAROCUR 4265 | photoinitiator | 1-14.3 | 1-7.3 |
| TIN292 | stabilizer | 1-16.1 | 1-9.1 |

The stereolithography resin can include photoinitiators. Photoinitiators generally accelerate curing. Photoinitiators can be present in the resin compositions in amounts from about 1 weight % to about 20 weight %. Preferably, the photoinitiators are present in the stereolithography resin from about 1 weight % to about 10 weight %. In some preferred embodiments of the photoinitiator is present in about 2 weight % to about 3 weight %. The photoinitiator can include a phosphine oxide, an alpha-hydroxyketone, benzophenone derivative, or mixtures thereof. The photoinitiator can include a component.

A combination of photoinitiators can be used so that light of different wavelength ranges can be used to facilitate curing of the resins. For example, photoinitiators can be chosen such that the radiation curable resin composition can be cured at wavelengths of about 240 nm to about 250 nm, about 360 nm to about 380 nm, or about 390 nm to about 410 nm. Resins having photoinitiators that allow for curing to occur at different wavelengths allow the use of a variety of light sources, such as a He/Cd laser, an argon laser, or various SLA instruments such as SLA 5000 or SLA 7000.

A combination of a phosphine oxide, an alpha-hydroxy ketone and a benzophenone derivative can be used as photoinitiators in the resin. This combination allows curing at different wavelengths. Such a combination of photoinitiators is sold by Sartomer, Inc. as SR1135 and is most useful in the wavelength ranges of about 240 nm to about 250 nm, about 260 nm to about 380 nm, and about 390 nm to about 410 nm. The photoinitiators are preferably present in the resins described above at weight percentages effective for initiating the light sensitive curing process. One skilled in the art can determine how much photoinitiator should be added for different photoinitiators and applications.

Many photoinitiators are known in the art and can be used with the stereolithography resins either singly or in a mixture. Photoinitiators can be selected from a group of substances capable to produce free radicals under the presence of visible light and/or UV radiation. Examples of these substances are 2-Hydroxy-2-methyl-1-phenyl-1-propanone (Darocur® 1173—Ciba SC) 2,4,6-trimehtylbenzoyl-dyphenyl-phosphineoxide (Darocur® TPO—Ciba SC) and mixture of these two.

Other examples of photoinitiators include a benzophenone, a benzil dimethyl ketal, a 1-hydroxy-cyclohexylphenylketone, an isopropyl thioxanthone, an ethyl 4-(dimethylamino)benzoate, a blend of 2,4,6-trimethylbenzoyldiphenyl phosphine oxide, 2,4,6-trimethylbenzophenone, 4-methylbenzophenone, and oligo(2-hydroxy-2-methyl-1-(4-(1-methylvinyl)phenyl)propanone, a benzoin normal butyl ether, a blend of oligo(2-hydroxy-2-methyl-1-4-(1-methylvinyl)phenyl propanone and poly(2-hydroxy-2-methyl-1-phenyl-1-propanone), tripropyleneglycol diacrylate, an oligo(2-hydroxy-2-methyl-1-(4-(1-methylvinyl)phenyl)propanone), a 2-hydroxy-2-methyl-1-phenyl-1-propanone, a poly(2-hydroxy-2-methyl-1-phenyl-1-propanone), a trimethylolpropane triacrylate, a SARCURE SR1137, a SARCURE SR1130, a phosphine oxide, a 4-methylbenzophenone, a trimethylbenzophenone, a methylbenzophenone, a Blend of 2,4,6-trimethylbenzoyl-diphenyl-phosphineoxide and hydroxy-2-methyl-1-phenyl-propan-1-one, and an Irgacure.

The radiation curable resin compositions can include light stabilizers. For example, Tinuvin 292 (TIN292) (bis(1,2,2,6,6-pentamethyl-4-piperidyl)sebacate and 1-(methyl)-10-(1,2,2,6,6-pentamethyl-4-piperidyl)sebacate) can be used as a stabilizer. Other stabilizers that can be used include, for example, Tinuvin 765 (bis(1,2,2,6,6-pentamethyl-4-piperidyl)sebacate) available from CIBA Specialty Chemicals, BLS 292 (bis(1,2,2,6,6-pentamethyl-4-piperidyl)sebacate and 1-(methyl)-10-(1,2,2,6,6-pentamethyl-4-piperidyl)sebacate) available from Mayzo Inc, 2-(2′-hydroxy-5′-methylphenyl)benztriole or 1,2,2,6,6-pentamethyl-4-piperidyle methacrylate a blend of oligo(2-hydroxy-2-methyl-1-4-(1-methylvinyl)phenyl propanone and poly(2-hydroxy-2-methyl-1-phenyl-1-propanone)available from ADK Stab, MEQH (4-methoxyphenol) available from Aldrich Chemical Company, Inc. and Chimassorb 81, available from Ciba Specialty Chemicals.

An inert fill can be included in the resins and improve performance characteristics of the resins. Inert fills reduce shrink to near zero. Such inert fills can include nanoclays and titanium dioxide. In various embodiments nanoclays such as Cloisite N and Cloisite 20A can be used.

In general, a stereolithography resin can be prepared from a base oligomer, a cross linking agent, a reactive solvent, and an anti-nucleation agent. The identity and relative concentrations of the base oligomer, reactive solvent, cross linking agent, and anti-nucleation agent can be selected to produce a resin with desired characteristics.

In some embodiments, the resins are used in methods for producing three dimensional objects using stereolithography. In general, stereolithography is carried out by forming a layer of a radiation curable resin composition and applying actinic radiation to cure at least a portion of the layer of the radiation curable resin composition form a cured layer. Then, a new layer of the radiation curable resin composition is introduced onto the cured layer, actinic radiation is applied to the new layer of the radiation curable resin composition to form another cured layer. These steps are repeated until a three dimensional object is manufactured. This methodology is well known in the art. See, for example, Jacobs, Paul F., Stereolithography and other RP & M Technologies (ASME Press, 1996), which is incorporated by reference in its entirety.

Upon application of light, photoinitiators produce reactive species that initiate rapid cure processes. A resin that includes photoinitiators is best stored in an environment in which it is protected from light. In certain preferred embodiments the photoinitiator is a blend of 2,4,6-trimethylbenzoyldiphenyl phosphine oxide, 2,4,6-trimethylbenzophenone, 4-methylbenzophenone, and oligo(2-hydroxy-2-methyl-1-(4-(1-methylvinyl)phenyl)propanone. In other preferred embodiments the photoinitiator is DAROCUR-4265, available from CIBA Specialty Chemicals Corp.

The resins can be cured with actinic radiation. The actinic radiation in preferred embodiments is provided by a laser. Suitable lasers are known in the art. For stereolithography applications, lasers are ordinarily provided with the stereolithography machine. Stereolithographic instruments that can be used include, for example, SLA 5000, or SLA 7000. Stereolithographic instruments can be purchased from 3D Systems (Valencia, Calif.).

In certain embodiments, three dimensional objects are prepared with the stereolithography resins described herein. Such three dimensional objects have properties depending on the stereolithography resin employed.

### EXAMPLES

Process to Prepare the Formulation
1. A base oligomer is heated to reach a temperature between 50 and 60° C. in order to reduce to melt any crystal or simply reduce it viscosity. Exceeding this range of temperature can produce degradation of the raw material.
2. If the cross-linking agent is also crystalline at room temperature, apply required heating to melt its crystals. At 50° C., the tris(2-hydroxy ethyl) isocyanurate triacrylate is a low viscosity monomer and a good solvent for UA oligomers.
3. The base oligomer and the cross-linking agent are mixed under elevated temperature (40° C.). The second oligomer (if any) is added to this mixture.
4. The reactive solvent is added reducing slowly the temperature to 30° C.
5. The anti-nucleation agent and the initiator are added at the end. Additional stirring at low shear is recommended to ensure full mixture of the resin, resulting in a resin with improved physical properties, such as low viscosity, low volumetric shrinkage, and anti-nucleation properties.

The following formulations have been used:

### Example 1

| Component | Function | % Wt range [g] |
|---|---|---|
| CN985B88 | Main oligomer | 40-60 |
| SR368 | Cross-linker | 10-30 |
| CN9001 | Second oligomer | 5-20 |
| SR423 | Reactive solvent | 10-30 |
| Antiblaze ® TMCP | Anti-nucleation agent | 2-10 |
| Darocur ® 1173 | Photo-initiator | 1-7 |

### Example 2

| Component | Function | % Wt range [g] |
|---|---|---|
| CN985B88 | Main oligomer | 50-70 |
| CD540 | Cross-linker | 15-20 |
| Mixture 50:50 SR423/SR506 | Reactive solvent | 10-20 |
| Antiblaze ® TMCP | Anti-nucleation agent | 2-10 |
| Darocur ® 4265 | Photo-initiator | 1-3 |

TABLE 10
Viscosity of uncured resin and physical properties of cured resin

| Property | Example 1 | Example 2 |
|---|---|---|
| Viscosity [cps] | | |
| @ 20° C. | 1100-1200 | 780-820 |
| @ 30° C. | 570-610 | 300-450 |
| Glass transition | 120 | 93 |
| temperature [° C.] | | |
| @66 PSI | | |
| @264 PSI | | |

A number of embodiments have been described. Nevertheless, it will be understood that various modifications may be made without departing from the spirit and scope of the invention.

What is claimed is:

1. A liquid stereolithography resin comprising a base oligomer, a reactive solvent, a cross linking agent, and an anti-nucleation agent or a pnictide-containing compound.

2. The liquid stereolithography resin of claim 1, wherein the anti-nucleation agent is a flame-retardant additive.

3. The liquid stereolithography resin of claim 1, further comprising a photoinitiator.

4. The liquid stereolithography resin of claim 3, wherein the photoinitiator includes a phosphine oxide, an alpha-hydroxyketone, and a benzophenone derivative.

5. The liquid stereolithography resin of claim 3, wherein the photoinitiator includes a component selected from the group consisting of a 2-hydroxy-2-methyl-1-phenyl-1-propanone, a 2,4,6-trimethylbenzoyl-diphenyl-phosphineoxide, or a combination thereof.

6. The liquid stereolithography resin of claim 3, wherein the photoinitiator includes a component selected from the group consisting of a blend of 2,4,6-trimethylbenzoyl-diphenyl-phosphineoxide and hydroxy-2-methyl-1-phenyl-propan-1-one, a phosphine oxide, a 2-hydroxy-2-methyl-1-phenyl-1-propanone, and mixtures thereof.

7. The liquid stereolithography resin of claim 3, wherein the photoinitiator activates polymerization of an acrylate in a wavelength range of 240 nm to 250 nm, 360 nm to 380 nm, or 390 nm to 410 nm.

8. The liquid stereolithography resin of claim 1, wherein the base oligomer includes an aliphatic urethane diacrylate.

9. The liquid stereolithography resin of claim 8, wherein the aliphatic urethane diacrylate is an aliphatic polyester urethane diacrylate.

10. The liquid stereolithography resin of claim 1, wherein the reactive solvent includes a monovalent acrylate.

11. The liquid stereolithography resin of claim 1, wherein the reactive solvent includes a polyvalent acrylate.

12. The liquid stereolithography resin of claim 1, wherein the base oligomer has formula (I): 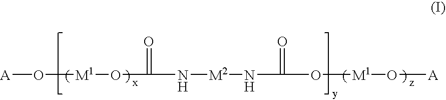
wherein
each M¹ is, independently, an alkylene, an acylalkylene, an oxyalkylene, an arylene, an acylarylene, or an oxyarylene, M¹ being optionally substituted with alkyl, cycloalkyl, alkenyl, cycloalkenyl, alkynyl, acyl, alkoxy, hydroxyl, hydroxylalkyl, halo, haloalkyl, amino, silicone, aryl, or aralkyl,
each M² is, independently, an alkylene or an arylene, M² being optionally substituted with alkyl, cycloalkyl, alkenyl, cycloalkenyl, alkynyl, acyl, alkoxy, hydroxyl, hydroxylalkyl, halo, haloalkyl, amino, silicone, aryl, or aralkyl,
each A, independently, has the formula: 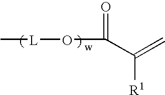
wherein R¹ is hydrogen or lower alkyl, each L is, independently, C₁-C₄ alkyl, and w is an integer ranging from 0 to 20, and
x is a positive integer less than 40, y is a positive integer less than 100, z is a positive integer less than 40, and w, x, y, and z together are selected such that the molecular weight of the base oligomer is less than 20,000.

13. The liquid stereolithography resin of claim 12, wherein M¹ is a straight, branched, or cyclic alkylene.

14. The liquid stereolithography resin of claim 12, wherein M¹ is an acylalkylene or acylarylene.

15. The liquid stereolithography resin of claim 14, wherein M² is a straight, branched, or cyclic alkylene.

16. The liquid stereolithography resin of claim 12, wherein M² is a straight, branched, or cyclic alkylene.

17. The liquid stereolithography resin of claim 12, wherein L is branched or unbranched C₁-C₄ alkyl.

18. The liquid stereolithography resin of claim 12, wherein the reactive solvent has formula (II):
A′-O—R²—(O-A′) (II)
wherein
R² is a monovalent or polyvalent moiety selected from the group consisting of a C₁-C₁₂ aliphatic group, an aromatic group, and a poly(C₁-C₄ branched or unbranched alkyl ether), R² being optionally substituted with alkyl, cycloalkyl, alkenyl, cycloalkenyl, alkynyl, acyl, alkoxy, hydroxyl, hydroxylalkyl, halo, haloalkyl, amino, aryl, or aralkyl,
n is an integer ranging from 0 to 5, and
each A′ has the formula: 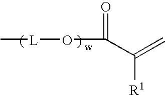
wherein R¹ is hydrogen or lower alkyl, each L independently is C₁-C₄ alkyl, and w is an integer ranging from 0 to 20.

19. The liquid stereolithography resin of claim 1, wherein the reactive solvent has formula (II):
A′-O—R²—(O-A′) (II)
wherein
R² is a monovalent or polyvalent moiety selected from the group consisting of a C₁-C₁₂ aliphatic group, an aromatic group, and a poly(C₁-C₄ branched or unbranched alkyl ether), R² being optionally substituted with alkyl, cycloalkyl, alkenyl, cycloalkenyl, alkynyl, acyl, alkoxy, hydroxyl, hydroxylalkyl, halo, haloalkyl, amino, aryl, or aralkyl,
n is an integer ranging from 0 to 5, and
each A′ has the formula: 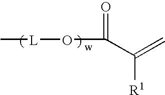
wherein R¹ is hydrogen or lower alkyl, each L independently is C₁-C₄ alkyl, and w is an integer ranging from 0 to 20.

20. The liquid stereolithography resin of claim 19, wherein L is branched or unbranched C₁-C₄ alkyl.

21. The liquid stereolithography resin of claim 1, wherein the reactive solvent agent includes an acrylate monomer.

22. The liquid stereolithography resin of claim 21, wherein the reactive solvent has formula (III): 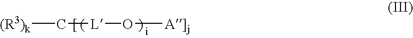
wherein
j is 1, 2, 3 or 4,
k is equal to 4-j,
R³ is hydrogen or C₁-C₄ branched or unbranched alkyl, each L′ independently is C₁-C₄ branched or unbranched alkyl, each i independently is 0, 1, 2 or 3, and
each A″ independently has the formula: 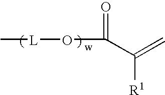
wherein R¹ is hydrogen or lower alkyl, each L independently is C₁-C₄ branched or unbranched alkyl, and w is an integer ranging from 0 to 20.

23. The liquid stereolithography resin of claim 1, wherein the cross linking agent includes a urethane acrylate oligomer.

24. The liquid stereolithography resin of claim 1, wherein the cross linking agent is a tris(2-hydroxyethyl)isocyanurate triacrylate or ethoxylated (4) bisphenol dimethyacrylate, or a mixture thereof.

25. The liquid stereolithography resin of claim 1, wherein the reactive solvent includes isobornyl acrylate, isobornyl methacrylate, and combinations thereof.

26. The liquid stereolithography resin of claim 1, further comprising a stabilizer.

27. The liquid stereolithography resin of claim 26, wherein the stabilizer is selected from the group consisting of Tinuvin 292 (bis(1,2,2,6,6-pentamethyl-4-piperidyl)sebacate and 1-methyl-10-(1,2,2,6,6-pentamethyl-4-piperidyl)sebacate), Tinuvin 765 (bis(1,2,2,6,6-pentamethyl-4-piperidyl)sebacate), MEQH (4-methoxyphenol), 2-(2′-hydroxy-5′-methylphenyl)benztriazole, 1,2,2,6,6-pentamethyl-4-piperidyl methacrylate and Chimassorb 81 (2-hydroxy-4-octyloxybenzophenone).

28. The liquid stereolithography resin of claim 1, wherein the base oligomer is CN964, the reactive solvent is ethoxylated (3) trimethylolpropane acrylate, and the cross linking agent is selected from the group consisting of isobornyl acrylate, ethoxylated (5) pentaerythritol tetraacrylate, CN965, tris-(2-hydroxyethyl)isocyanurate triacrylate, and mixtures thereof.

29. The liquid stereolithography resin of claim 28, wherein the resin includes 5-35 weight % CN964 and 0.5-25 weight % ethoxylated (3) trimethylolpropane acrylate.

30. The liquid stereolithography resin of claim 29, wherein the resin includes 0.5-20 weight % isobornyl acrylate.

31. The liquid stereolithography resin of claim 29, wherein the resin includes 15-45 weight % ethoxylated (5) pentaerythritol tetraacrylate.

32. The liquid stereolithography resin of claim 29, wherein the resin includes 0.5-25 weight % CN965.

33. The liquid stereolithography resin of claim 29, wherein the resin includes 5-35 weight % tris-(2-hydroxyethyl)isocyanurate triacrylate.

34. The liquid stereolithography resin of claim 1, wherein the base oligomer is CN963, the reactive solvent is tripropyleneglycol diacrylate, and the cross linking agent is selected from the group of CN970H75, ethoxylated (4) bisphenol A dimethyacrylate, isobornyl acrylate, and mixtures thereof.

35. The liquid stereolithography resin of claim 34, wherein the resin includes 40-70 weight % CN963, and 5-35 weight % tripropyleneglycol diacrylate.

36. The liquid stereolithography resin of claim 35, wherein the resin includes 0.5-15 weight % CN970H75.

37. The liquid stereolithography resin of claim 35, wherein the resin includes 0.5-15 weight % ethoxylated (4) bisphenol A dimethyacrylate.

38. The liquid stereolithography resin of claim 35, wherein the resin includes 5-35 weight % isobornyl acrylate.

39. The liquid stereolithography resin of claim 1, wherein the base oligomer is CN966, the reactive solvent is isobornyl acrylate, and the cross linking agent is selected from the group consisting of isobornyl acrylate, ethoxylated (4) bisphenol A dimethyacrylate, and mixtures thereof.

40. The liquid stereolithography resin of claim 39, wherein the resin includes 10-40 weight % CN966 and 0.5-25 weight % isobornyl acrylate.

41. The liquid stereolithography resin of claim 39, wherein the resin includes 6-35 weight % isobornyl acrylate.

42. The liquid stereolithography resin of claim 39, wherein the resin includes 25-55 weight % ethoxylated (4) bisphenol A dimethyacrylate.

43. The liquid stereolithography resin of claim 1, wherein the base oligomer is CN990, the reactive solvent is isobornyl acrylate, and the cross linking agent is selected from the group consisting of CN131, a polyether modified acryl functional polydimethylsiloxane, and mixtures thereof.

44. The liquid stereolithography resin of claim 43, wherein the resin includes 50-80 weight % CN990 and 0.5-20 weight % isobornyl acrylate.

45. The liquid stereolithography resin of claim 44, wherein the resin includes 5-35 weight % CN131.

46. The liquid stereolithography resin of claim 44, wherein the resin includes 0.5-15 weight % A polyether modified acryl functional polydimethylsiloxane.

47. The liquid stereolithography resin of claim 1, wherein the base oligomer is CN973, the reactive solvent is isobornyl acrylate, and the cross linking agent is isobornyl acrylate.

48. The liquid stereolithography resin of claim 47, wherein the resin includes 45-75 weight % CN973 and 10-70 weight % isobornyl acrylate.

49. The liquid stereolithography resin of claim 1, wherein the base oligomer is CN963, the reactive solvent is tripropyleneglycol diacrylate, and the cross linking agent is selected from the group consisting of CN2400, isobornyl acrylate, and mixtures thereof.

50. The liquid stereolithography resin of claim 49, wherein the resin includes 20-50 weight % CN963 and 0.5-25 weight % tripropyleneglycol diacrylate.

51. The liquid stereolithography resin of claim 50, wherein the resin includes 10-40 weight % CN2400.

52. The liquid stereolithography resin of claim 50, wherein the resin includes 10-40 weight % isobornyl acrylate.

53. The liquid stereolithography resin of claim 1, wherein the base oligomer is CN966, the reactive solvent is isobornyl acrylate, and the cross linking agent is selected from the group consisting of CN131 and isobornyl acrylate.

54. The liquid stereolithography resin of claim 53, wherein the resin includes 35-60 weight % CN966 and 10-25 weight % isobornyl acrylate.

55. The liquid stereolithography resin of claim 53, wherein the resin includes 10-45 weight % isobornyl acrylate.

56. The liquid stereolithography resin of claim 53, wherein the resin includes 5-35 weight % CN131.

57. The liquid stereolithography resin of claim 1, wherein the pnictide-containing compound is an organopnictide.

58. The liquid stereolithography resin of claim 1, wherein the pnictide-containing compound is a halogenated organopnictide.

59. A method of forming a three-dimensional object comprising:
heating a base oligomer;
heating a cross linking agent;
mixing the oligomer and cross linking agent together to form a mixture;
adding reactive solvent to form a resin;
adding an anti-nucleation agent or a pnictide-containing compound to the resin; and
selectively exposing the resin to light to form a solidified layer.

60. The method of claim 59, further comprising adding a photoinitiator or a stabilizer.

61. The method of claim 59, wherein the desired characteristic of the finished product is dimensional stability and the precursor is isobornyl acrylate.

62. A method of forming a three-dimensional object comprising:
selectively exposing to actinic radiation a first portion of a resin including a base oligomer, a reactive solvent, a cross linking agent, and an anti-nucleation agent or a pnictide-containing compound to form a first solidified layer; and
selectively exposing to actinic radiation a second portion of the resin to form a second solidified layer adjacent to the first solidified layer.

63. A method of forming a three-dimensional object comprising:
heating a base oligomer;
heating a cross linking agent;
mixing the oligomer and cross linking agent together to form a mixture;
adding reactive solvent to form a resin;
adding a pnictide-containing compound to the resin; and
selectively exposing the resin to light to form a solidified layer.
